(19) United States
(12) Patent Application Publication
(10) Pub. No.: US 2024/0373925 A1
(43) Pub. Date: Nov. 14, 2024

(54) AEROSOL GENERATING DEVICE, AEROSOL GENERATING SYSTEM, AND AEROSOL GENERATING METHOD

(71) Applicant: KT&G CORPORATION, Daejeon (KR)

(72) Inventor: Young Bum KWON, Yongin-si (KR)

(73) Assignee: KT&G CORPORATION, Daejeon (KR)

(21) Appl. No.: 18/611,129

(22) Filed: Mar. 20, 2024

(30) Foreign Application Priority Data
May 10, 2023 (KR) 10-2023-0060563
Jul. 11, 2023 (KR) 10-2023-0089759

(51) Int. Cl. A24F 40/46; A24F 40/20; A24F 40/53; A24F 40/57; H05B 1/02

(52) U.S. Cl. CPC A24F 40/46; A24F 40/20; A24F 40/53; A24F 40/57; H05B 1/0252

(57) ABSTRACT

An aerosol generating device includes a heater configured to generate aerosols by heating an aerosol generating material, a power supply configured to supply power to the heater, and a controller configured to control operations of the power supply and the heater, wherein the heater includes a sheet including a first heating region and a second heating region, a first track that is heated by receiving power and arranged in the first heating region, and a second track that is heated by receiving power and arranged in the second heating region, and the controller is further configured to control the power supply to supply power to the second track when a predetermined time has elapsed after starting to supply power to the first track.

### CROSS-REFERENCE TO RELATED APPLICATIONS

This application is based on and claims priority under 35 U.S.C. § 119 to Korean Patent Application No. 10-2023-0060563, filed on May 10, 2023, and Korean Patent Application No. 10-2023-0089759, filed on Jul. 11, 2023, in the Korean Intellectual Property Office, the disclosures of which are incorporated by reference herein in their entirety.

### BACKGROUND

### 1. Field

The disclosure relates to an aerosol generating device, an aerosol generating system, and an aerosol generating method, and more particularly, to an aerosol generating device including a plurality of electrically conductive tracks, an aerosol generating system, and an aerosol generating method using a plurality of electrically conductive tracks.

### 2. Description of the Related Art

Recently, the demand for a technology for replacing a method of supplying an aerosol by burning a general cigarette has been increased. For example, there is an increasing demand for a system for generating aerosols by heating a cigarette or an aerosol generating material by using an aerosol generating device, rather than by burning cigarettes. Accordingly, research into a heating-type aerosol generating device has been actively conducted.

A resistance heater may be used as a heater for electrically heating the aerosol generating material. The resistance heater may include an electric resistor, wherein, when a current flows through the electric resistor, the resistance heater is heated and the aerosol generating material is heated, and thus, aerosols may be generated.

### SUMMARY

An aerosol generating device including a resistance heater may include an electrically conductive track, and the resistance heater may be heated as a current flows through the electrically conductive track. However, the resistance heater including the electrically conductive track may have a low power efficiency due to overheating and life of the resistance heater may not be sufficient.

Provided are an aerosol generating device, an aerosol generating system, and an aerosol generating method, in which power efficiencies are enhanced.

Provided are an aerosol generating device, an aerosol generating system, and an aerosol generating method, in which overheating is prevented.

Provided are an aerosol generating device, an aerosol generating system, and an aerosol generating method, in which durability and life are enhanced.

Provided are an aerosol generating device, an aerosol generating system, and an aerosol generating method, in which a temperature of a heater may be determined without having to use a separate temperature sensor.

Additional aspects will be set forth in part in the description which follows and, in part, will be apparent from the description, or may be learned by practice of the presented embodiments of the disclosure.

An aerosol generating device according to an embodiment includes a heater configured to generate aerosols by heating an aerosol generating material, a power supply configured to supply power to the heater, and a controller configured to control operations of the power supply and the heater, wherein the heater includes a sheet including a first heating region and a second heating region, a first track that is heated by receiving power and arranged in the first heating region, and a second track that is heated by receiving power and arranged in the second heating region, and the controller is further configured to control the power supply to supply power to the second track when a predetermined time has elapsed after starting to supply power to the first track.

An aerosol generating system according to an embodiment includes an aerosol generating device including a heater configured to generate aerosols by heating an aerosol generating material, a power supply configured to supply power to the heater, and a controller configured to control operations of the power supply and the heater, and an aerosol generating article including a generating portion that includes the aerosol generating material and configured to generate aerosols by being heated by the aerosol generating device, wherein the heater includes a sheet including a first heating region and a second heating region, a first track that is heated by receiving power and arranged in the first heating region, and a second track that is heated by receiving power and arranged in the second heating region, and the controller is further configured to control the power supply to supply power to the second track when a predetermined time has elapsed after starting to supply power to the first track.

An aerosol generating method for an aerosol generating device that is heated by receiving power and includes a first track and a second track, which generate aerosols by heating an aerosol generating material, according to an embodiment, includes supplying power to the first track and supplying power to the second track when a first time has elapsed after the supplying of the power to the first track.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram of an aerosol generating device according to an embodiment;

FIG. 2 is a front perspective view of an aerosol generating device according to an embodiment;

FIG. 3 is a rear perspective view of an aerosol generating device according to an embodiment;

FIG. 4 is a rear perspective view of an internal structure of an aerosol generating device, which includes an insulator and a printed circuit board, according to an embodiment;

FIG. 5 is a rear perspective view of an internal structure of an aerosol generating device, which includes a battery, according to an embodiment;

FIG. 6 is a rear exploded perspective view of an internal structure according to an embodiment;

FIG. 7 is a plan view for describing a sheet and a track of a heater of an aerosol generating device, according to an embodiment;

FIG. 8 is a plan view for describing a sheet and a track of a heater of an aerosol generating device, according to an embodiment;

FIG. 9 is a diagram for describing an arrangement of an aerosol generating article and a heater of an aerosol generating device, according to an embodiment;

FIG. 10 is a diagram for describing an arrangement of an aerosol generating article and a heater of an aerosol generating device, according to another embodiment;

FIG. 11 is a graph for describing a change in supply power with respect to a track, according to an aerosol generating method, according to an embodiment;

FIG. 12 is a flowchart of an aerosol generating method according to an embodiment;

FIG. 13 is a flowchart of an aerosol generating method according to another embodiment;

FIG. 14 is a flowchart of an aerosol generating method according to another embodiment; and

FIG. 15 is a block diagram of an aerosol generating device according to an embodiment.

### DETAILED DESCRIPTION

With respect to the terms used to describe the various embodiments, general terms which are currently and widely used are selected in consideration of functions of structural elements in the various embodiments of the disclosure. However, meanings of the terms can be changed according to intention, a judicial precedence, the appearance of new technology, and the like. In addition, in certain cases, terms which can be arbitrarily selected by the applicant in particular cases. In such a case, the meaning of the terms will be described in detail at the corresponding portion in the description of the disclosure. Therefore, the terms used in the various embodiments of the disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

In addition, while describing an embodiment of the present specification, detailed descriptions of the related prior art may be omitted when it is determined that the detailed descriptions may obscure the gist of the embodiment disclosed of the present specification. It should be understood that the accompanying drawings are only for easy understanding of the embodiment of the present specification, and technical ideas in the present specification are not limited by the accompanying drawings and include all changes, equivalents, and substitutes included in the ideas and technical scope of the disclosure.

While terms including ordinal numbers, such as “first”, “second”, etc., may be used to describe various components, such components are not limited to the above terms. The above terms are used only to distinguish one component from another.

When a component is “connected” or “accessed” to another component, the component may be directly connected or accessed to the other component, but it may also be understood that there may be an intervening component therebetween. On the other hand, when a component is “directly connected” or “directly accessed” to another component, it may be understood that there is no intervening component therebetween.

An expression used in the singular encompasses the expression in the plural, unless it has a clearly different meaning in the context.

Hereinafter, embodiments will be described in detail with reference to the accompanying drawings such that one of ordinary skill in the art may easily implement the embodiments. However, the disclosure may be implemented in various different forms and is not limited to an embodiment described herein.

Same reference numerals are assigned to same or similar elements, and redundant descriptions thereof are omitted.

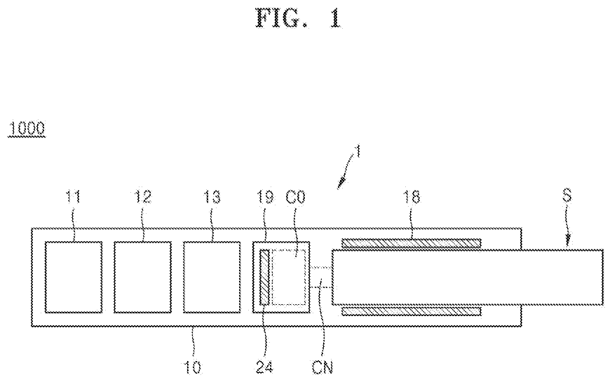

FIG. 1 illustrates an aerosol generating system including an aerosol generating device 1 and an aerosol generating article S, according to embodiments.

Referring to FIG. 1, the aerosol generating device 1 may include at least one of a power supply 11, a controller 12, a sensor 13, and a heater 18. At least one of the power supply 11, the controller 12, the sensor 13, and the heater 18 may be arranged inside a body 10. The body 10 may provide a space opened upward such that the aerosol generating article S is inserted. The aerosol generating article S may also be referred to as a stick, a cigarette, or the like, but is not limited thereto. The aerosol generating article S may include an aerosol generating material and generate aerosols by using the aerosol generating device 1. The aerosol generating system 1000 may include the aerosol generating device 1 and the aerosol generating article S, but is not limited thereto.

The opened space of the aerosol generating device 1 may be referred to as an insertion space. The insertion space may be formed by being sunken into the body 10 by a predetermined depth such that at least a portion of the aerosol generating article S is inserted. A depth of the insertion space may correspond to a length of a region of the aerosol generating article S, which includes the aerosol generating material and/or medium. A lower end of the aerosol generating article S may be inserted into the body 10 and an upper end of the aerosol generating article S may protrude outside the body 10. A user may inhale the air while holding the upper end of the aerosol generating article S that is externally exposed in his/her mouth.

The heater 18 may heat the aerosol generating article S. When the aerosol generating article S is heated, the aerosols may be generated. In other words, the heater 18 may generate the aerosols by heating the aerosol generating article S. The heater 18 may extend long upward around the space where the aerosol generating article S is inserted. For example, the heater 18 may have a tube shape including a hollow therein. The heater 18 may be arranged around the insertion space. The heater 18 may be arranged to surround at least a portion of the insertion space. The heater 18 may heat the insertion space or the aerosol generating article S inserted into the insertion space. The heater 18 may include an electric resistance heater and/or an induction heating type heater.

For example, referring to FIG. 1, the heater 18 may be a resistance heater. For example, the heater 18 may include an electrically conductive track and the heater 18 may be heated as a current flows through the electrically conductive track. The heater 18 may be electrically connected to the power supply 11. The power supply 11 may supply power to the heater 18. The heater 18 may directly generate heat by receiving the current from the power supply 11. The heater 18 may be a heater having a hollow shape and heat the outside of the aerosol generating article S by being arranged to surround at least a portion of the aerosol generating article S inserted into the insertion space, or may be a heater having a needle shape, a rod shape, or a tube shape and heat the inside of the aerosol generating article S by being inserted into the aerosol generating article S that is inserted into the insertion space.

For example, the heater 18 may be a multi-heater. The heater 18 may include a first heater and a second heater. The first heater and the second heater may be arranged in parallel in a length direction. The first heater and the second heater may be instantaneously heated and may be simultaneously heated.

The power supply 11 may supply power to operate components of the aerosol generating device 1. The power supply 11 may be referred to as a battery. The power supply 11 may supply power to at least one of the controller 12, the sensor 13, and the heater 18. When the heater 18 includes the electrically conductive track, the power supply 11 may supply power to the electrically conductive track.

The controller 12 may control all operations of the aerosol generating device 1. The controller 12 may be mounted on a printed circuit board (PCB). The controller 12 may control operations of at least one of the power supply 11 and the sensor 13. The controller 12 may control operations of the heater 18. The controller 12 may control operations of a display, a motor, and the like included in the aerosol generating device 1. The controller 12 may identify a state of each component of the aerosol generating device 1 and determine whether the aerosol generating device 1 is operable.

The controller 12 may analyze a result detected by the sensor 13 and control processes to be performed thereafter. For example, the controller 12 may control power supplied to the heater 18 such that an operation of the heater 18 is started or ended, based on the result detected by the sensor 13. For example, the controller 12 may control an amount of power supplied to the heater 18 or a time of supplying power such that the heater 18 is heated up to a predetermined temperature or maintains a suitable temperature, based on the result detected by the sensor 13.

The sensor 13 may include at least one of a temperature sensor, a puff sensor, and an insertion detection sensor. For example, the sensor 13 may sense at least one of a temperature of the heater 18, a temperature of the power supply 11, and a temperature inside and outside of the body 10. For example, the sensor 13 may sense the user's puff. For example, the sensor 13 may sense whether the aerosol generating article S is inserted into the insertion space.

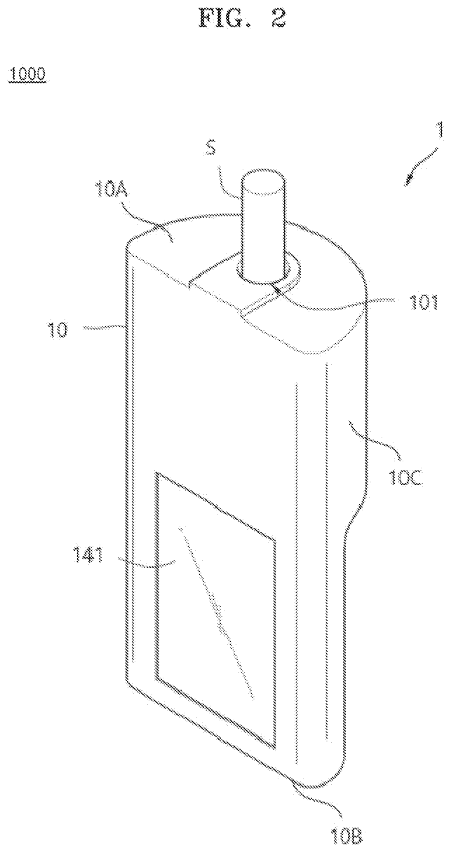

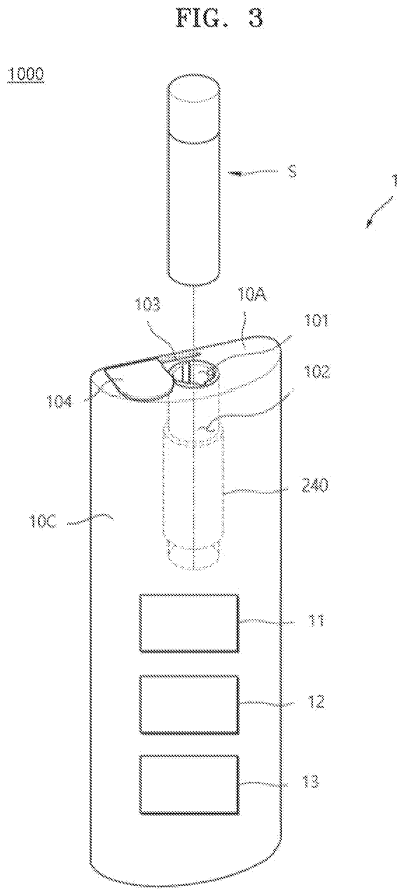

FIG. 2 is a front perspective view of the aerosol generating device 1 according to an embodiment, and FIG. 3 is a rear perspective view of the aerosol generating device 1 according to an embodiment.

Referring to FIG. 2, the aerosol generating device 1 according to an embodiment may include at least one of a power supply, a controller, and a sensor. At least one of the power supply, the controller, and the sensor may be arranged inside the body 10 of the aerosol generating device 1. Same details of the power supply 11, the controller 12, and the sensor 13 described above with reference to FIG. 1 may be applied to the power supply, the controller, and the sensor.

The body 10 forms an overall outer appearance of the aerosol generating device 1 and may include an internal space where the components of the aerosol generating device 1 are arranged. In FIG. 2, an embodiment in which an overall cross section of the body 10 has a semicircular shape is illustrated, but a shape of the body 10 is not limited thereto. For example, the body 10 may have a cylindrical shape or a polygonal pillar shape in overall.

The body 10 may include a first body surface 10A (e.g., a body front surface), a second body surface 10B (e.g., a body rear surface) opposite to the first body surface 10A, and at least one third body surface 10C (e.g., a body side surface) between the first body surface 10A and the second body surface 10B.

Referring to FIG. 3, the body 10 may include an insertion space 102 therein. The insertion space 102 may be provided at a top portion of the body 10. The insertion space 102 may be opened upward. The insertion space 102 may have a cylindrical shape extending long in a vertical direction, but is not limited thereto. At least a portion of the aerosol generating article S may be inserted into the body 10 through an opening 101 at the top of the insertion space 102. A depth of the insertion space 102 may correspond to a length of a region of the aerosol generating article S, which includes an aerosol generating material and/or medium.

A heater 240 may surround at least a portion of the outside of the insertion space 102. The heater 240 may extend long along the insertion space 102 in the vertical direction. For example, the heater 240 may be a cylindrical electric resistance heater surrounding at least a portion of the insertion space 102. The heater 240 may heat the outside of the aerosol generating article S accommodated in the insertion space 102. At least one region of the aerosol generating article S accommodated in the insertion space 102 may be heated by the heater 240 and aerosols may be generated when vaporized particles generated by heating the aerosol generating article S and the air introduced to an internal space of the body 10 through the opening 101 are mixed.

A display 141 may be arranged on one side of the body 10. At least partial region of the display 141 may be exposed outside the body 10.

The display 141 may provide various types of visual information to a user. The display 141 may include a display panel and/or a touch panel. The display 141 may include a cover glass.

The cover glass may form the outer appearance of the aerosol generating device 1 together with the body 10. The cover glass may be in contact with a part of a body of the user. The cover glass may protect the display panel and/or the touch panel from an external impact.

The display panel may be arranged in a direction from the cover glass towards the inside of the body 10. The display panel may be arranged in parallel to the cover glass.

The touch panel may detect a touch corresponding to a contact of an object. For example, the touch panel may detect a touch corresponding to a contact of a part of the body of the user. The touch panel may receive an input of the user.

A cover 104 may be provided at the top of the body 10. The cover 104 may have a shape corresponding to a shape of the opening 101 of the body 10. For example, the opening 101 of the body 10 may be circular, and the cover 104 may be circular and have a greater diameter than the opening 101.

The cover 104 may be movably connected to a guide 103 provided in the body 10. The cover 104 may move along the guide 103. For example, the guide 103 may be a groove formed on one surface of the body 10 and the cover 104 may include a protrusion that slides while being inserted into the groove of the body 10. For example, the guide 103 may be a protrusion protruding from one surface of the body 10 and the cover 104 may include a groove inserted into the protrusion to slide along the protrusion.

The cover 104 may open or close the opening 101 of the body 10 by moving along the guide 103. For example, the cover 104 may close the opening 101 at a first location and open the opening 101 at a second location. A location of the cover 104 may be manually moved by the user. Alternatively, the aerosol generating device 1 may include a driving device and the location of the cover 104 may be moved by the driving device.

The body 10 may include a connecting terminal (not shown). The connecting terminal may include a connector enabling the aerosol generating device 1 to be physically connected to an external electronic device. For example, the connecting terminal may include at least one or a combination of a high-definition multimedia interface (HDMI) connector, a universal serial bus (USB) connector, a secure digital (SD) card connector, and an audio connector (e.g., a headphone connector).

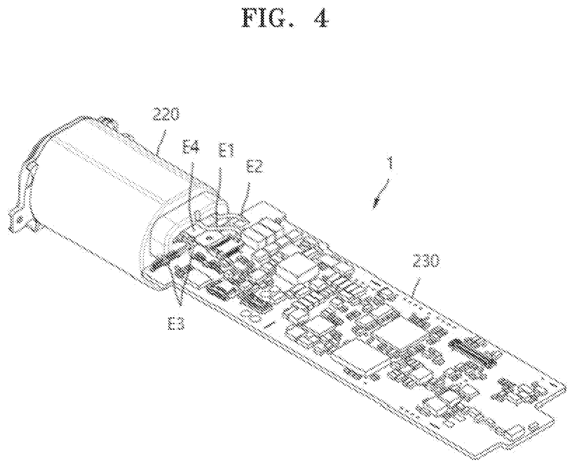

FIG. 4 is a rear perspective view of an internal structure of the aerosol generating device 1, which includes an insulator 220 and a printed circuit board 230, according to an embodiment.

Referring to FIG. 4, the aerosol generating device 1 may include the insulator 220. The insulator 220 may be configured to thermally insulate the heater 240. The insulator 220 may include the heater 240 inside the insulator 220. The insulator 220 may include an antenna (not shown) (e.g., a liquid crystal display (LCD) antenna) inside the insulator 220.

The insulator 220 is arranged to surround the heater 240 to seal the heater 240 and prevent droplets, which are generated during an aerosol generating process through the heater 240, from externally leaking, and thus, the components of the aerosol generating device 1 may be prevented from malfunctioning or being damaged by the droplets.

The insulator 220 seals the heater 240 and prevents heat generated by the heater 240 from being transmitted to an outer circumference of the body 10, and thus, even when a temperature of the heater 240 is maintained high, high-temperature heat may be prevented from being transmitted to the body (e.g., a palm) of the user holding the body 10.

The aerosol generating device 1 may include the printed circuit board 230. For example, the printed circuit board 230 may include at least one or a combination of the controller 12, the sensor 13, a memory 17, and a communication unit 16.

The aerosol generating device 1 may include a plurality of electrical lines, i.e., first through fourth electrical lines E1 to E4. For example, the first electrical line E1 may be configured to connect the heater 240 and a temperature sensor to each other. The second electrical line E2 may be configured to connect the heater 240 and the printed circuit board 230 to each other. At least one third electrical line E3 may be configured to connect at least one sensor and the printed circuit board 230 to each other. The fourth electrical line E4 may be configured to connect a heater housing of the heater 240 and the printed circuit board 230 to each other. The fourth electrical line E4 may include a flexible printed circuit board.

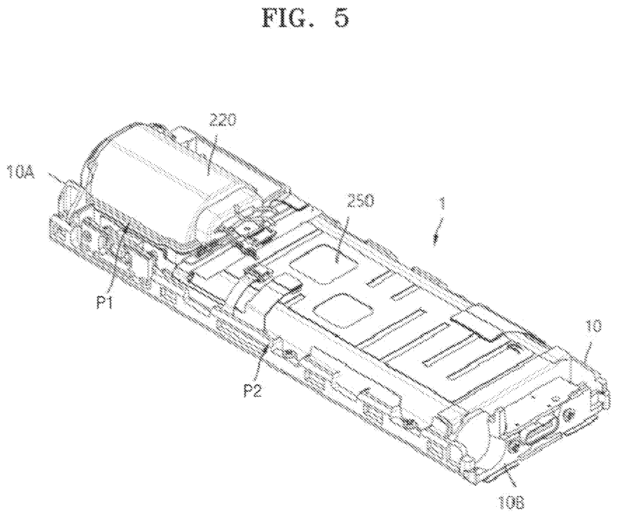

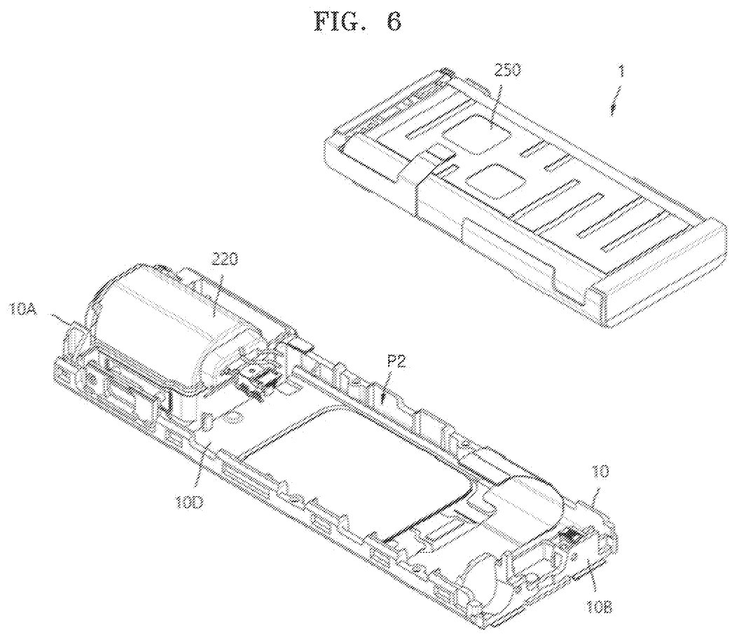

FIG. 5 is a rear perspective view of an internal structure of the aerosol generating device 1, which includes a battery, according to an embodiment, and FIG. 6 is a rear exploded perspective view of the internal structure according to an embodiment.

Referring to FIGS. 5 and 6, the body 10 of the aerosol generating device 1 may include a first portion P1. The first portion P1 may include a portion adjacent to the first body surface 10A of the body 10. The body 10 may include a second portion P2. The second portion P2 may be at least partially different from the first portion P1. The second portion P2 may include a portion adjacent to the second body surface 10B of the body 10.

The body 10 may include a wall. The wall may separate the first portion P1 and the second portion P2 from each other. The wall may extend from an inner surface 10D of the body 10 in a direction perpendicular to the inner surface 10D. The wall may extend across the inner surface 10D in a direction (e.g., a width direction of the body 10) crossing a vertical direction (e.g., a thickness direction of the body 10) of the inner surface 10D of the body 10. The direction may cross a direction (e.g., a length direction of the body 10) from the first body surface 10A to the second body surface 10B of the body 10.

A power supply 250 may be arranged in the second portion P2 of the body 10. The power supply 250 may include a pouch type battery. The power supply 250 may be arranged adjacent to the printed circuit board 230. For example, the power supply 250 may be arranged at one side of the inner surface 10D of the body 10 and the printed circuit board 230 may be arranged at another side of the power supply 250, which is opposite to the one side of the inner surface 10D. However, arrangements of the printed circuit board 230 and the power supply 250 are not limited thereto.

The heater 240 may be arranged in the first portion P1 of the body 10.

The insulator 220 may thermally insulate the heater 240. The insulator 220 may be arranged in the first portion P1 of the body 10. The insulator 220 may surround the heater 240.

The aerosol generating device 1 may include a buffer structure (not shown). The buffer structure may be configured to buffer the power supply 250. The buffer structure may be arranged in at least a portion of the inner surface 10D of the second portion P2 of the body 10. The buffer structure may reduce or block an impact applied to the power supply 250 when an external impact is applied to the aerosol generating device 1.

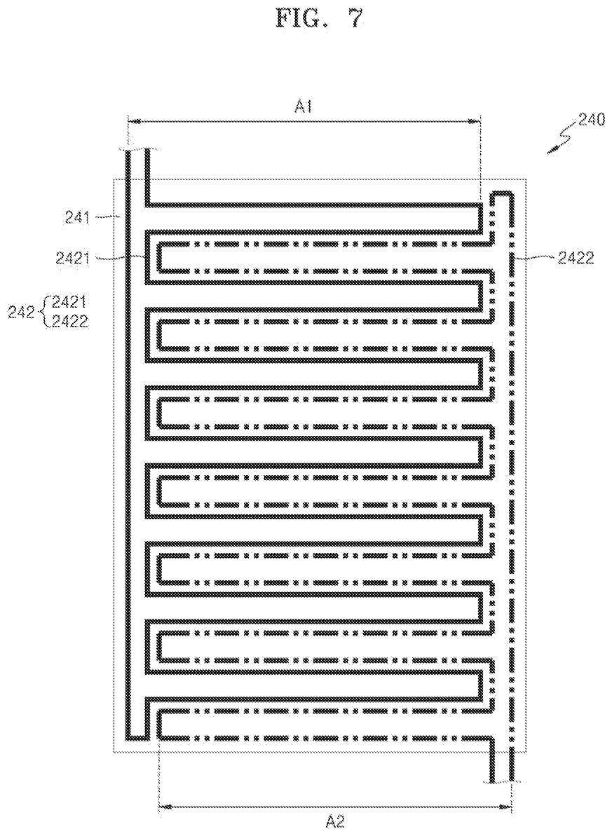

FIG. 7 is a plan view for describing a sheet 241 and a track 242 included in the heater 240 of an aerosol generating device, according to an embodiment.

Same details described above with reference to the other drawings may be applied to the heater 240. The heater 240 may heat an aerosol generating article. The heater 240 may be arranged inside a body of the aerosol generating device. The heater 240 may be an electric resistance heater.

For stable usage, power according to the standard of 3.2 V, 2.4 A, and 8 W may be supplied to the heater 240, but is not limited thereto. For example, when power is supplied to the heater 240, a surface temperature of the heater 240 may be increased to 400° C. or greater. The surface temperature of the heater 240 may be increased up to about 350° C. before 15 seconds elapse from when power starts to be supplied to the heater 240.

The heater 240 may include the sheet 241. The track 242 may be arranged in the sheet 241. The sheet 241 may include a flexible material.

The sheet 241 may include a thermally conductive material. Examples of the thermally conductive material may include a ceramic including alumina or zirconia, an anodized metal, a coated metal, and polyimide (PI), but is not limited thereto.

The sheet 241 may be a green sheet including a ceramic synthetic material. Here, the ceramic may include a compound, such as alumina or zirconia, but is not limited thereto.

The sheet 241 may protect the track 242 arranged inside the sheet 241 from an external impact. For example, the sheet 241 may prevent the aerosol generating article from damaging the track 242 when the aerosol generating article is moved to be accommodated in or discharged from the aerosol generating device. The sheet 241 may be coated with glaze such that durability is enhanced.

The sheet 241 may be divided into regions. For example, a partial region of the sheet 241 may be a first heating region A1, and another partial region may be a second heating region A2. The sheet 241 may include the first heating region A1 and the second heating region A2. The first heating region A1 and the second heating region A2 may not need to be independent from each other. For example, the first heating region A1 and the second heating region A2 may at least partially overlap each other. The first heating region A1 and the second heating region A2 of the sheet 241 shown in FIG. 7 include an overlapping region.

The heater 240 may include the track 242. The track 242 is an electrically conductive track and the heater 240 may be heated as a current flows through the track 242. The track 242 may generate heat by receiving power. The track 242 may be electrically connected to a power supply included in the aerosol generating device. The track 242 may receive power from the power supply. A temperature of the heater 240 may be increased as a current flows through the track 242, and thus, a temperature of the aerosol generating article may be increased.

A cartridge (not shown) may be detachably combined to the aerosol generating device. The cartridge may contain an aerosol generating material. The heater 240 may be a configuration for heating the aerosol generating material contained in the cartridge. The aerosol generating material contained in the cartridge may be liquid. The aerosol generating material contained in the cartridge may be absorbed by a liquid delivery element (not shown) and heated by the heater 240. The liquid delivery element may be a wick including cotton fiber, ceramic fiber, glass fiber, or porous ceramic.

The track 242 of the heater 240 may have a structure of a coil shape winding up the liquid delivery element or a structure in contact with one side of the liquid delivery element. When the liquid delivery element is heated by the heater 240, aerosols may be generated.

A heating temperature of the track 242 may be determined according to power consumption of a resistor of the track 242. Also, a resistance value of the track 242 may be set based on the power consumption of the resistor of the track 242. The resistance value of the track 242 may be set based on a material, length, width, thickness, and pattern of the track 242. In the track 242, a size of internal resistance may be increased such that a temperature is increased according to a resistance temperature coefficient characteristic. For example, the temperature and the size of resistance of the track 242 may be in proportion to each other within a predetermined temperature range.

For example, the track 242 may include tungsten, gold, platinum, silver, copper, nickel, palladium, or a combination thereof. A suitable doping material may be doped on the track 242 or the track 242 may include an alloy.

There may be a plurality of tracks 242. The tracks 242 may include a first track 2421 and a second track 2422.

The plurality of tracks 242 may be arranged separately on both surfaces of the sheet 241 or may be arranged together on one surface of the sheet 241.

The plurality of tracks 242 may be arranged at different heating regions of the sheet 241 to heat the sheet 241. For example, the first track 2421 may be arranged in the first heating region A1 to heat the first heating region A1 and the second track 2422 may be arranged in the second heating region A2 to heat the second heating region A2. A region where the first heating region A1 and the second heating region A2 overlap may be heated by both the first track 2421 and the second track 2422. In other words, the first track 2421 and the second track 2422 may heat a same region.

Heating element density may be defined as the area of the heating region, which is occupied by the track 242. The first track 2421 and the second track 2422 may have same heating element density. For example, the area of first track 2421 occupying the first heating region A1 may be the same as the area of the second track 2422 occupying the second heating region A2.

The first track 2421 and the second track 2422 may be electrically connected to the power supply to receive power. The first track 2421 and the second track 2422 may independently receive power from the power supply. For example, the first track 2421 and the second track 2422 may be electrically connected in parallel to one power supply. Accordingly, supplies of power to the first track 2421 and the second track 2422 do not affect each other and thus may be individually controlled. For example, the power supply may supply power to the second track 2422 when a predetermined time has elapsed after starting to supply power to the first track 2421. A controller may control the power supply to independently supply power to the first track 2421 and the second track 2422 as such.

By independently controlling power to the first track 2421 and the second track 2422, power consumption of the tracks 242 may be efficiently controlled.

In general, an electrically conductive track has a lifespan and the life of a heating device may depend thereupon. According to the heater 240 of the disclosure, the second track 2422 may be controllable and operable even when the first track 2421 is uncontrollable and/or inoperable. In addition, the first track 2421 may be controllable and operable even when the second track 2422 is uncontrollable and/or inoperable. Accordingly, durability and life of the heater 240 of the aerosol generating device may be enhanced and operation stability of the heater 240 may be guaranteed. In other words, the first track 2421 and the second track 2422 may be preliminary configurations preparing for uncontrollability and/or inoperability of each other.

When a current flows through the track 242, a temperature of the sheet 241 may be increased.

A heating temperature of the track 242 may be determined according to power consumption of a resistor of the track 242. Also, a resistance value of the track 242 may be set based on the power consumption of the resistor of the track 242. Here, the resistance value of the track 242 may be set based on a material, length, width, thickness, and pattern of the track 242.

In the track 242, a size of internal resistance may be increased such that a temperature is increased according to a resistance temperature coefficient characteristic. For example, the temperature and the size of resistance of the track 242 may be in proportion to each other within a predetermined temperature range. In other words, the track 242 may be a type of variable resistor in which resistance changes according to a temperature. Accordingly, the track 242 may perform a function of a temperature sensor providing information about a temperature.

For example, a predetermined voltage may be applied to the track 242 and a current flowing through the track 242 may be measured through a current detector. Also, resistance of the track 242 may be calculated through a ratio of the measured current to the applied voltage. A temperature of the track 242 or the sheet 241 may be estimated according to the resistance temperature coefficient characteristic of the track 242, based on the calculated resistance.

According to the disclosure, any one of the first track 2421 and the second track 2422 may be used as a temperature sensor. For example, when the sheet 241 is heated by using the first track 2421, the second track 2422 may be used as a temperature sensor. As another example, when the sheet 241 is heated by using the second track 2422, the first track 2421 may be used as a temperature sensor. The controller may calculate information about a temperature, based on the amount of current flowing through the first track 2421 and/or the second track 2422. The controller may control operations of overall configurations of the aerosol generating device according to such information about a temperature.

The sheet 241 may include an electric conductive material. For example, the sheet 241 may include graphene. Graphene is polymer carbon allotropes that form a 2-dimensional plane structure in which carbon atoms are connected to each other in a hexagonal honeycomb shape, and may have excellent electric conductivity while having a shape of a thin film.

A predetermined voltage may be applied to the sheet 241 including the electric conductive material, and a current flowing through the sheet 241 may be measured by using a current detector. Also, resistance of the sheet 241 may be calculated through a ratio of the measured current to the applied voltage. A temperature of the sheet 241 or the track 242 may be estimated according to the resistance temperature coefficient characteristic of the sheet 241, based on the calculated resistance. According to the disclosure, the sheet 241 including the electric conductive material may be used as a temperature sensor. The controller may calculate information about a temperature, based on the amount of current flowing through the sheet 241. The controller may control operations of overall configurations of the aerosol generating device according to such information about a temperature.

The aerosol generating device may further include a temperature sensor separately from the track 242 performing a function of a temperature sensor. The controller may calculate a temperature of the heater 240 by using the track 242 of the heater 240 or by using the temperature sensor separately provided in the aerosol generating device.

The track 242 includes an electric resistance material. For example, the track 242 may be manufactured in a metal material. As another example, the track 242 may be manufactured in an electric conductive ceramic material, carbon, a metal alloy, or a composite material of a ceramic material and a metal.

When the heater 240 of the aerosol generating device is heated to a sufficiently high temperature and the temperature of the heated heater 240 is maintained for a predetermined time, a material deposited on a surface of the heater 240 and/or on a space into which the aerosol generating article is inserted may be volatized, and thus, a cleaning effect may occur.

Also, the aerosol generating device may include a puff detection sensor, a temperature detection sensor, and/or a cigarette insertion detection sensor. For example, the puff detection sensor may be realized by using a general pressure sensor. Alternatively, the aerosol generating device may not include a separate puff detection sensor and may detect a puff according to a resistance change of the track 242 included in the heater 240. Here, the track 242 may denote both a track for generating heat and/or a track for detecting a temperature. Alternatively, the aerosol generating device may further include the puff detection sensor separately from the detecting a puff by using the track 242 included in the heater 240.

The first track 2421 and the second track 2422 may be manufactured selectively in a same material group, for example, tungsten, gold, platinum, silver, copper, nickel, palladium, or a combination thereof. Here, even when a material of the first track 2421 and a material of the second track 2422 are the same, resistance values of the first track 2421 and the second track 2422 may be different from each other according to a difference in lengths, widths, or patterns of tracks.

The track 242 may have any one of various patterns, such as a curve pattern, a mesh pattern, and the like. For example, at least a portion of the first track 2421 may include a first pattern region in which an extending direction is regularly changed. Similarly, at least a portion of the second track 2422 may include a second pattern region in which an extending direction is regularly changed.

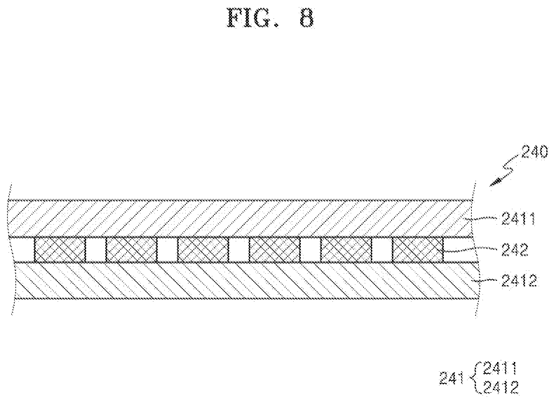

FIG. 8 is a plan view for describing the sheet 241 and the track 242 included in the heater 240 of the aerosol generating device, according to an embodiment. Same details described above with reference to FIG. 7 and the like may be applied to the sheet 241 and the track 242 of the heater 240.

The track 242 of FIG. 8 may be any one of the first track 2421 and the second track 2422 of FIG. 7.

The sheet 241 may have a structure in which two components are stacked on each other. For example, the sheet 241 may have a structure in which a first sheet 2411 and a second sheet 2412 are stacked on each other.

The heater 240 may include the track 242. The track 242 may be arranged inside the sheet 241. For example, the track 242 may be provided between the first sheet 2411 and the second sheet 2412 of the sheet 241, but an arrangement of the track 242 and the sheet 241 is not limited thereto.

The track 242 may be heated when power is supplied thereto, thereby heating the sheet 241. The track 242 may receive power by being connected to a power supply.

The sheet 241 may include a thermally conductive material. Examples of the thermally conductive material may include a ceramic including alumina or zirconia, an anodized metal, a coated metal, and polyimide (PI), but is not limited thereto.

The sheet 241 may be a green sheet including a ceramic synthetic material. Here, the ceramic may include a compound, such as alumina or zirconia, but is not limited thereto.

The first sheet 2411 and/or the second sheet 2412 may have rigidity.

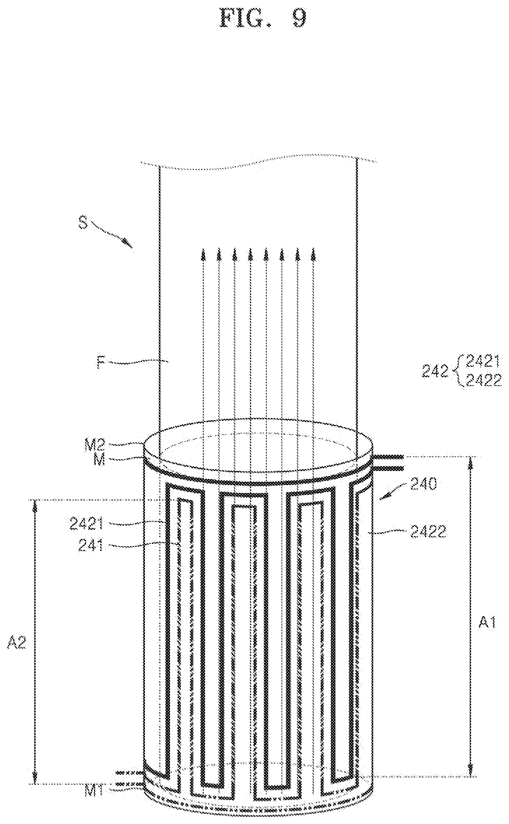

FIG. 9 is a diagram for describing an arrangement of the aerosol generating article S and the heater 240 included in the aerosol generating device, according to an embodiment. Same details described above with reference to the other drawings may be applied to the heater 240.

The sheet 241 may have a curved surface. At least a portion of the aerosol generating article S may be accommodated at an inner side of the curved surface formed of the sheet 241. The sheet 241 may be configured to transmit heat to the aerosol generating article S. For example, the sheet 241 may receive heat from the track 242 and transmit the heat to the aerosol generating article S. The sheet 241 having a curved shape may surround at least a portion of an outer surface of the aerosol generating article S and heat an outer side of the aerosol generating article S to generate aerosols.

As another example, the sheet 241 may form the curved surface while the aerosol generating article S may be arranged on an outer side of the curved surface of the sheet 241. Here, the sheet 241 may have a needle shape (e.g., a shape in which a cylinder and a cone are combined). The sheet 241 having the needle shape may be inserted into at least a portion of an inner side of the aerosol generating article S and heat the inner side of the aerosol generating article S to generate aerosols.

The sheet 241 may include one or more films. For example, the sheet 241 may have a structure in which two films are stacked on each other. A film arranged on an inner side of the curved surface of the sheet 241 may be referred to as an inner film, and a film arranged on an outer side thereof may be referred to as an outer film.

The heater 240 may include the track 242. The track 242 may be arranged inside the sheet 241. For example, the track 242 may be provided between the outer film and the inner film of the sheet 241, but an arrangement of the track 242 and the sheet 241 is not limited thereto. The inner film may protect the outer film and the track 242 when the aerosol generating article S is inserted into the heater 240.

There may be the plurality of tracks 242. The tracks 242 may include the first track 2421 and the second track 2422. The track 242 may be connected to a printed circuit board (not shown) through at least one electrical line.

Referring to FIG. 3 described above together, the heater 240 may be arranged to surround the insertion space 102 of the aerosol generating device 1. An article insertion portion 205 may guide insertion of the aerosol generating article S into the heater 240.

The aerosol generating article S may include a generating portion M and a filter portion F. In FIG. 9, the filter portion F is illustrated as a single segment, but is not limited thereto. In other words, the filter portion F may include a plurality of segments. For example, the filter portion F may include a segment for cooling the aerosols and a segment for filtering out a specific component included in the aerosols. Also, when necessary, the filter portion F may further include at least one segment for performing another function.

A diameter of the aerosol generating article S may be within a range of 5 mm to 9 mm and a length thereof may be about 48 mm, but the aerosol generating article S is not limited thereto. For example, a length of the generating portion M may be about 12 mm, a length of a first segment of the filter portion F may be about 10 mm, a length of a second segment of the filter portion F may be about 14 mm, and a length of a third segment of the filter portion F may be about 12 mm, but an embodiment is not limited thereto.

The aerosol generating article S may be wrapped by at least one wrapper (not shown). The wrapper may include at least one hole through which external air is introduced or an internal gas is discharged. For example, the aerosol generating article S may be wrapped by one wrapper. As another example, the aerosol generating article S may be repeatedly wrapped by two or more wrappers.

The generating portion M includes aerosol generating material. For example, the aerosol generating material may include, but is not limited to, at least one of glycerin, propylene glycol, ethylene glycol, dipropylene glycol, diethylene glycol, triethylene glycol, tetraethylene glycol, and oleyl alcohol. Also, the generating portion M may contain other additives, such as flavors, wetting agent, and/or organic acid. Flavored liquid, such as menthol or a moisturizer, may be added to the generating portion M by being ejected to the generating portion M.

The generating portion M may be variously formed. For example, the generating portion M may be formed as a sheet or a strand. The generating portion M may be formed as a pipe tobacco, which is formed of tiny bits cut from a tobacco sheet. The generating portion M may be surrounded by a heat conductive material. For example, the heat conductive material may be, but not limited thereto, a metal foil such as an aluminum foil. For example, the heat conductive material surrounding the generating portion M may uniformly distribute heat transmitted to the generating portion M, and thus, heat conductivity applied to a tobacco rod may be increased and taste of a tobacco may be improved. The heat conductive material surrounding the generating portion M may function as a susceptor heated by an induction heating type heater. Here, although not illustrated in the drawings, the generating portion M may further include an additional susceptor, in addition to the heat conductive material surrounding the outside of the generating portion M.

The filter portion F may include a cellulose acetate filter. Shapes of the filter portion F are not limited. For example, the filter portion F may include a cylinder-type rod or a tube-type rod having a hollow inside. Alternatively, the filter portion F may include a recess-type rod. When the filter portion F includes a plurality of segments, at least one of the plurality of segments may have a different shape.

Also, the filter portion F may include at least one capsule. Here, the capsule may generate a flavor or aerosols. For example, the capsule may have a configuration in which a liquid containing a flavoring material is wrapped with a film. The capsule may have a spherical or cylindrical shape, but is not limited thereto.

The aerosol generating article S may be heated by the heater 240. In detail, the heater 240 may heat at least a portion of the generating portion M of the aerosol generating article S. The heated generating portion M may generate aerosols.

When at least a portion of the generating portion M is heated, a stream including the aerosols (hereinafter, an aerosol stream) may flow in a direction from one end portion M1 to another end portion M2 of the generating portion M (a direction indicated by arrows in the aerosol generating article S of FIG. 9). The aerosol stream may flow from a bottom portion to a top portion of the generating portion M, based on the aerosol generating article S of FIG. 9.

The aerosols generated by heating the generating portion M is generated over the one end portion M1 to the other end portion M2 of the generating portion M and moves towards the other end portion M2. In other words, the other end portion M2 of the generating portion M corresponds to a downstream of the aerosol stream. Here, when the other end portion M2 of the generating portion M is not sufficiently heated, the downstream of the aerosol stream may not be sufficiently heated and the aerosol generating material inside the generating portion M may not be efficiently heated, and thus, an aerosol generating efficiency may be decreased.

An end portion of the track 242 may be arranged at a location corresponding to the other end portion M2 of the generating portion M. For example, an end portion of at least one of the first track 2421 and the second track 2422 may be arranged at the location corresponding to the other end portion M2 of the generating portion M. In FIG. 9, the end portion of the first track 2421 is arranged at the location corresponding to the other end portion M2 of the generating portion M, but an embodiment is not limited thereto, and the end portion of the second track 2422 may be arranged at the location corresponding to the other end portion M2 of the generating portion M.

By arranging the heater 240 and the aerosol generating article S as such, the track 242 may sufficiently heat the downstream of the aerosol stream by sufficiently heating the other end portion M2 of the generating portion M and may efficiently heat the aerosol generating material inside the generating portion M, and thus, the aerosol generating efficiency may be increased.

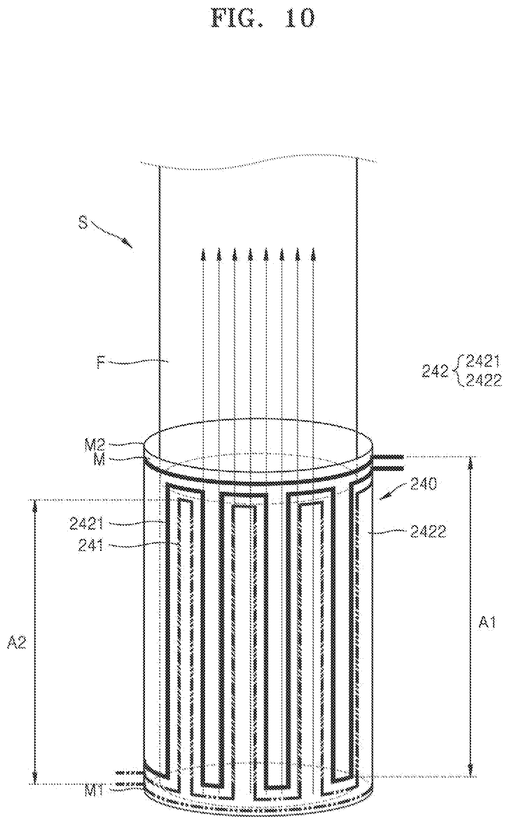

FIG. 10 is a diagram for describing an arrangement of the aerosol generating article S and the heater 240 included in the aerosol generating device, according to another embodiment. Same details described above with reference to the other drawings may be applied to the heater 240.

The sheet 241 may have a curved surface. At least a portion of the aerosol generating article S may be accommodated at an inner side of the curved surface formed of the sheet 241. The sheet 241 may be configured to transmit heat to the aerosol generating article S.

The heater 240 may include the track 242. The track 242 may be arranged inside the sheet 241.

There may be the plurality of tracks 242. The tracks 242 may include the first track 2421 and the second track 2422. The track 242 may be connected to a printed circuit board (not shown) through at least one electrical line.

The aerosol generating article S may include the generating portion M and the filter portion F. In FIG. 10, the filter portion F is illustrated as a single segment, but is not limited thereto.

The generating portion M includes an aerosol generating material. The generating portion M may be variously formed.

The aerosol generating article S may be heated by the heater 240. In detail, the heater 240 may heat at least a portion of the generating portion M of the aerosol generating article S. The heated generating portion M may generate aerosols.

When at least a portion of the generating portion M is heated, a stream including the aerosols (hereinafter, the aerosol stream) may flow in a direction from the one end portion M1 to the other end portion M2 of the generating portion M (a direction indicated by arrows in the aerosol generating article S of FIG. 10). The aerosol stream may flow from the bottom portion to the top portion of the generating portion M, based on the aerosol generating article S of FIG. 10.

The aerosols generated by heating the generating portion M is generated over the one end portion M1 to the other end portion M2 of the generating portion M and moves towards the other end portion M2. In other words, the other end portion M2 of the generating portion M corresponds to a downstream of the aerosol stream. Here, when the other end portion M2 of the generating portion M is not sufficiently heated, the downstream of the aerosol stream may not be sufficiently heated and the aerosol generating material inside the generating portion M may not be efficiently heated, and thus, an aerosol generating efficiency may be decreased.

For example, an end portion of at least one of the first track 2421 and the second track 2422 may be spaced apart from the other end portion M2 of the generating portion M by a predetermined distance in a direction the aerosol stream flows. In FIG. 10, the end portion of the first track 2421 is spaced apart from the other end portion M2 of the generating portion M by the predetermined distance in the direction the aerosol stream flows, but an embodiment is not limited thereto, and the end portion of the second track 2422 may be spaced apart from the other end portion M2 of the generating portion M by the predetermined distance in the direction the aerosol stream flows.

By arranging the heater 240 and the aerosol generating article S as such, the track 242 may sufficiently heat the downstream of the aerosol stream by sufficiently heating not only the other end portion M2 of the generating portion M but also the aerosol stream flowing through the other end portion M2, and may efficiently heat the aerosol generating material inside the generating portion M, and thus, an aerosol generating efficiency may be increased.

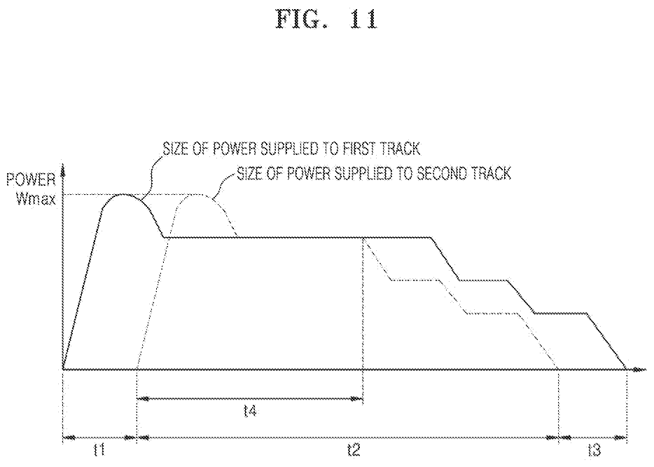

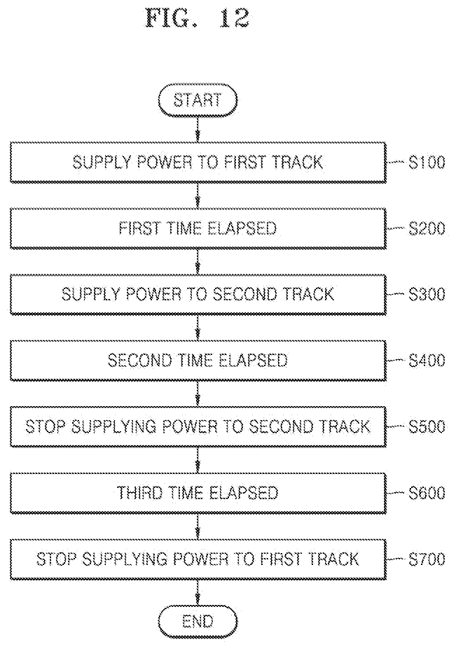

FIG. 11 is a graph for describing supply power with respect to a time of a track of a heater shown in FIGS. 7 to 10. FIG. 12 is a flowchart of an aerosol generating method, in which aerosols are generated through the heater shown in FIGS. 7 to 10.

The aerosol generating method will now be described with reference to FIGS. 11 and 12.

The aerosol generating method according to the disclosure is for an aerosol generating device including a first track and a second track, which are heated by receiving power and heat an aerosol generating material to generate aerosols.

The aerosol generating method according to an embodiment may be performed by a controller included in the aerosol generating device, but is not limited thereto.

Referring to FIG. 12, the aerosol generating method according to an embodiment may include supplying power to the first track (operation S100), determining whether a first time has elapsed from operation S100 (operation S200), and supplying power to the second track when the first time has elapsed from operation S100 (operation S300). For example, the first time may correspond to t1 in the graph of FIG. 11.

The aerosol generating method of the disclosure may further include determining whether a second time has elapsed from operation S300 (operation S400) and stopping the supplying of power to the second track when the second time has elapsed from operation S300 (operation S500). For example, the second time may correspond to t2 in the graph of FIG. 11.

The aerosol generating method of the disclosure may further include determining whether a third time has elapsed from operation S500 (operation S600) and stopping the supplying of power to the first track when the third time has elapsed from operation S500 (operation S700). For example, the third time may correspond to t3 in the graph of FIG. 11.

However, the aerosol generating method described above is only an example and the stopping of the supplying of power to the first track and the stopping of the supplying of power to the second track may be simultaneously performed. As another example, the stopping of the supplying of power to the second track may be performed after the stopping of the supplying of power to the first track. As such, power supplied to the first track and the second track may be stopped individually and may be differently controlled according to a specific operation situation.

According to FIGS. 11 and 12 and the aerosol generating method described above, the second track may receive power later than the first track and stop receiving power before the first track. A time of supplying power to the first track may be equal to the sum of the first time t1, the second time t2, and the third time t3 and a time of supplying power to the second track may be equal to the second time t2, and thus, the first track receives power longer than the second track and a duration of heating by the first track may be longer than a duration of heating by the second track. The described control method for the first track and the control method for the second track may be applied interchangeably.

Referring to FIG. 11, a size of power supplied to the second track may follow a size of power supplied to the first track before a fourth time has elapsed from operation S300, and the size of power supplied to the first track may follow the size of power supplied to the second track when the fourth time has elapsed from operation S300. For example, the fourth time may correspond to t4. Here, the phrase “follow a size of power” indicates that power supply to one track is identically repeated after a predetermined time so as to be applied to power supply of another track. In other words, “follow a size of power” indicates that a pattern of power supply to one track is repeated for another track after a predetermined time.

For example, referring to FIG. 11, power supply to the second track may follow power supply to the first track during the fourth time t4 after the supply of power to the second track starts, and the power supply to the first track may follow the power supply to the second track after the fourth time t4.

According to such an aerosol generating method, one track follows power supply of another track, and thus, overheating or malfunction of the track may be prevented.

According to the aerosol generating method of the disclosure, by independently controlling power to the first track and the second track, power consumption required to heat an aerosol generating material may be efficiently controlled.

In general, the track 242 has a lifespan and the life of a heating device may depend thereupon. According to the aerosol generating method of the disclosure, the second track may be controllable and operable even when the first track is uncontrollable and/or inoperable. In addition, the first track may be controllable and operable even when the second track is uncontrollable and/or inoperable. Accordingly, durability and life of a heater of an aerosol generating device may be enhanced and operation stability of the heater may be guaranteed.

In other words, the first track and the second track may preliminarily operate in preparation for uncontrollability and/or inoperability of each other.

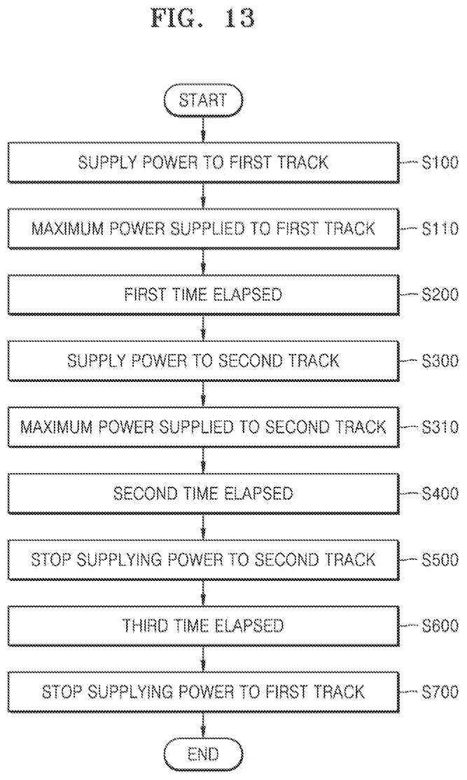

FIG. 13 is a flowchart of an aerosol generating method, in which aerosols are generated through the heater shown in FIGS. 7 to 10. Same details of the aerosol generating method described above with reference to FIG. 12 may be applied to the aerosol generating method described with reference to FIG. 13. To avoid redundant descriptions, details that have been described with reference to FIG. 12 may be omitted.

The aerosol generating method will now be described with reference to FIGS. 11 and 13.

First, referring to FIG. 11, the size of power supplied to the first track may be gradually decreased after reaching a maximum value Wmax and the size of power supplied to the second track may also be gradually decreased after reaching the maximum value Wmax.

Only one maximum value Wmax is illustrated in the graph of FIG. 11, but this is only for convenience of illustration and a maximum value of power supplied to the first track and a maximum value of power supplied to the second track may be different from each other.

Referring to FIG. 13, the aerosol generating method of the disclosure may further include, after the supplying of power to the first track (operation S100), reaching the maximum value of the power supplied to the first track (operation S110). In addition, the aerosol generating method of the disclosure may further include, after the supplying of power to the second track (operation S300) after operation S110, reaching the maximum value of the power supplied to the second track (operation S310).

Other operations of the aerosol generating method may be the same as or similar to the aerosol generating method described above with reference to FIG. 12. The described control method for the first track and the control method for the second track may be applied interchangeably.

According to the aerosol generating method described above with reference to FIGS. 11 and 13, the second track may receive the maximum value of power later than the first track. By sequentially applying maximum power supply to the first track and the second track, overheating of an aerosol generating article may be prevented, and by independently controlling power to the first track and the second track, power consumption required to heat an aerosol generating material may be efficiently controlled.

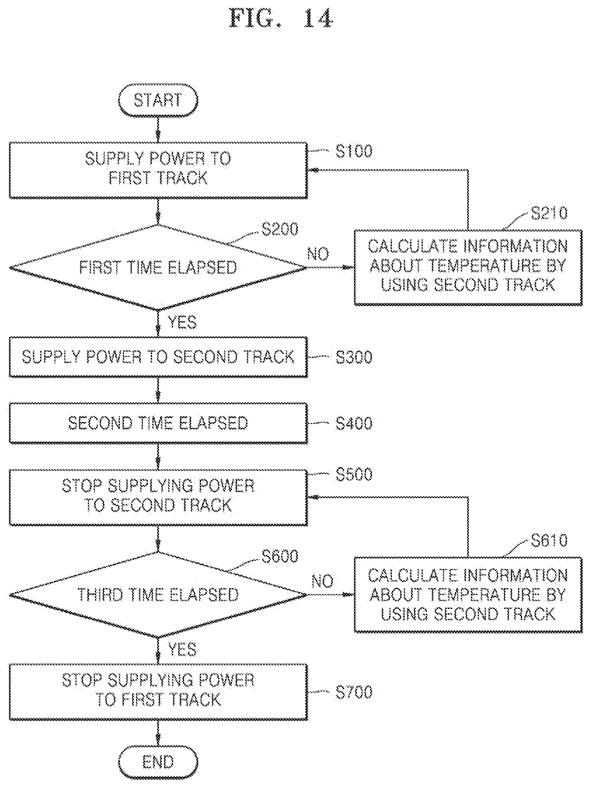

FIG. 14 is a flowchart of an aerosol generating method, in which aerosol are generated through the heater shown in FIGS. 7 to 10. Same details of the aerosol generating method described above with reference to FIG. 12 may be applied to the aerosol generating method described with reference to FIG. 14. To avoid redundant descriptions, details that have been described with reference to FIG. 12 may be omitted.

The aerosol generating method will now be described with reference to FIGS. 11 and 14.

Referring to FIG. 14, the aerosol generating method according to an embodiment may include supplying power to the first track (operation S100), determining whether the first time has elapsed from operation S100 (operation S200), and supplying power to the second track when the first time has elapsed from operation S100 (operation S300). For example, the first time may correspond to t1 in the graph of FIG. 11.

The aerosol generating method of the disclosure may further include calculating information about a temperature, based on the amount of current flowing through the second track, when the first time t1 has not elapsed after operation S100 (operation S210). In other words, the second track that is not used before power is supplied to the second track to heat the second track may be used as a temperature sensor of a heater.

The aerosol generating method of the disclosure may further include determining whether the third time has elapsed from operation S500 (operation S600) and stopping the supplying of power to the first track when the third time has elapsed from operation S500 (operation S700). For example, the third time may correspond to t3 in the graph of FIG. 11.

The aerosol generating method of the disclosure may further include calculating the information about the temperature, based on the amount of current flowing through the second track, when the third time t3 has not elapsed after operation S500 (operation S610). In other words, the second track that is not used after power is stopped from being supplied to the second track to heat the second track may be used as the temperature sensor.

Details about the calculating of the information about the temperature by using the second track have been described above with reference to FIG. 7.

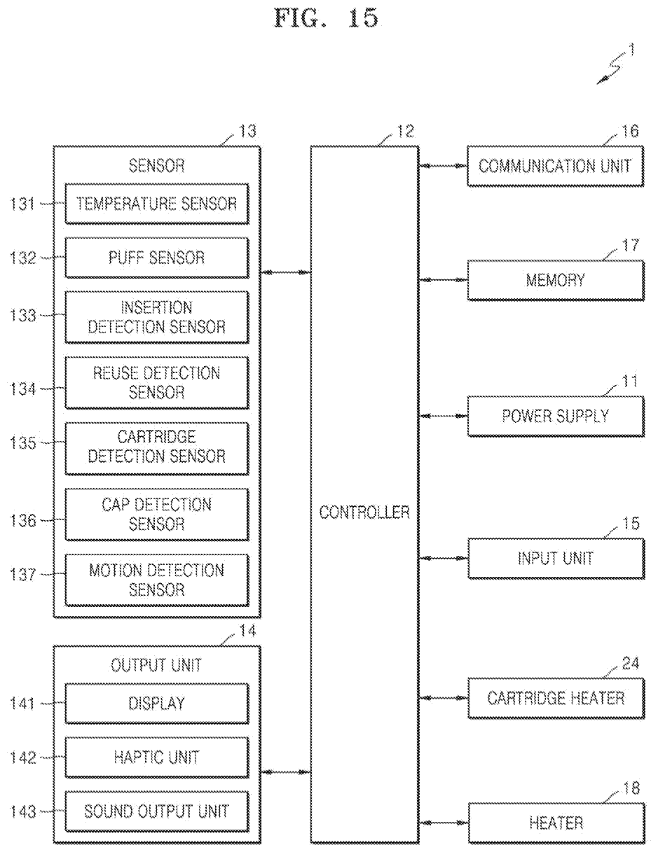

FIG. 15 is a block diagram of the aerosol generating device 1 according to an embodiment.

The aerosol generating device 1 may include the power supply 11, the controller 12, the sensor 13, an output unit 14, an input unit 15, the communication unit 16, the memory 17, and at least one heater, for example, the heater 18 and a cartridge heater 24. However, the internal structure of the aerosol generating device 1 is not limited to those illustrated in FIG. 15. That is, according to the design of the aerosol generating device 1, it will be understood by one of ordinary skill in the art that some of the components shown in FIG. 15 may be omitted or new components may be added.

The sensor 13 may sense a state of the aerosol generating device 1 and a state around the aerosol generating device 1, and transmit sensed information to the controller 12. The controller 12 may control the aerosol generating device 1 based on the detected information such that various functions, such as control of an operation of the heater 18 and/or cartridge heater, limitation of smoking, determination on whether an aerosol generating article S and/or cartridge 19 is inserted, and display of notification are performed.

The sensor 13 may include at least one of a temperature sensor 131, a puff sensor 132, an insertion detection sensor 133, a reuse detection sensor 134, a cartridge detection sensor 135, a cap detection sensor 136, and a motion detection sensor 137.

The temperature sensor 131 may detect a temperature at which the cartridge heater 24 and/or the heater 18 are/is heated. The aerosol generating device 1 may include a separate temperature sensor configured to detect the temperature of the cartridge heater 24 and/or the heater 18, or the cartridge heater 24 and/or the heater 18 may function as a temperature sensor.

The temperature sensor 131 may output a signal corresponding to the temperature of the cartridge heater 24 and/or the heater 18. For example, the temperature sensor 131 may include a resistance element in which a resistance value changes based on a temperature change of the cartridge heater 24 and/or the heater 18. The resistance element may be realized by a thermistor that is an element using a property in which resistance changes according to a temperature. Here, the temperature sensor 131 may output a signal corresponding to a resistance value of the resistance element as the signal corresponding to the temperature of the cartridge heater 24 and/or the heater 18. For example, the temperature sensor 131 may be configured as a sensor detecting a resistance value of the cartridge heater 24 and/or the heater 18. In this case, the temperature sensor 131 may output a signal corresponding to the resistance value of the cartridge heater 24 and/or the heater 18 as the signal corresponding to the temperature of the cartridge heater 24 and/or the heater 18.

The temperature sensor 131 may be arranged around the power supply 11 to monitor a temperature of the power supply 11. The temperature sensor 131 may be arranged adjacent to the power supply 11. For example, the temperature sensor 131 may be attached to one surface of a battery that is the power supply 11. For example, the temperature sensor 131 may be mounted on one surface of a printed circuit board.

The temperature sensor 131 may detect an internal temperature of the body 10 (see FIGS. 1 to 3) by being arranged inside the body 10.

The puff sensor 132 may detect a puff of a user, based on various physical changes in an airflow path. The puff sensor 132 may output a signal corresponding to the puff. For example, the puff sensor 132 may be a pressure sensor. The puff sensor 132 may output a signal corresponding to internal pressure of the aerosol generating device 1. Here, the internal pressure of the aerosol generating device 1 may correspond to pressure of the airflow path in which a gas moves. The puff sensor 132 may be arranged according to the airflow path in which a gas moves in the aerosol generating device 1.

The insertion detection sensor 133 may detect insertion and/or removal of the aerosol generating article S. The insertion detection sensor 133 may detect a signal change according to the insertion and/or removal of the aerosol generating article S. The insertion detection sensor 133 may be provided around an insertion space. The insertion detection sensor 133 may detect the insertion and/or removal of the aerosol generating article S according to a change in a dielectric constant inside the insertion space. For example, the insertion detection sensor 133 may be an inductive sensor and/or a capacitance sensor.

The inductive sensor may include at least one coil. The coil of the inductive sensor may be arranged adjacent to the insertion space. For example, when a magnetic field changes around the coil through which a current flows, characteristics of the current flowing through the coil may change according to the Faraday's law of electromagnetic induction. Here, the characteristics of the current flowing through the coil may include a frequency of an alternating current, a current value, a voltage value, an inductance value, and an impedance value.

The inductive sensor may output a signal corresponding to the characteristics of the current flowing through the coil. For example, the inductive sensor may output a signal corresponding to the inductance value of the coil.

The capacitance sensor may include a conductor. The conductor of the capacitance sensor may be arranged adjacent to the insertion space. The capacitance sensor may output a signal corresponding to a surrounding electromagnetic characteristic, for example, capacitance around the conductor. For example, when the aerosol generating article S including a wrapper including a metal material is inserted into the insertion space, an electromagnetic characteristic around the conductor may be changed by the wrapper of the aerosol generating article S.

The reuse detection sensor 134 may detect reuse of the aerosol generating article S. The reuse detection sensor 134 may be a color sensor. The color sensor may detect a color of the aerosol generating article S. The color sensor may detect a color of a portion of the wrapper surrounding the outside of the aerosol generating article S. The color sensor may detect a value of an optical characteristic corresponding to a color of an object, based on a light reflected from the object. For example, the optical characteristic may be a wavelength of the light. The color sensor may be implemented as one component with a proximity sensor or as a separate component distinguished from the proximity sensor.

A color of at least a portion of the wrapper included in the aerosol generating article S may be changed by aerosols. The reuse detection sensor 134 may be arranged according to a location where the at least a portion of the wrapper, of which the color is changed by aerosols, is arranged, when the aerosol generating article S is inserted into the insertion space. For example, the color of the at least a portion of the wrapper may be a first color before the aerosol generating article S is used by a user. When the at least a portion of the wrapper is wet by aerosols as the aerosols generated by the aerosol generating device 1 passes through the aerosol generating article S, the color of the at least a portion of the wrapper may be changed to a second color. Meanwhile, the color of the at least a portion of the wrapper may maintain the second color after being changed from the first color.

The cartridge detection sensor 135 may detect installation and/or removal of a cartridge. The cartridge detection sensor 135 may be implemented as an inductance-based sensor, a capacitance type sensor, a resistance sensor, or a hall sensor (hall integrated chip (IC)) using a hall effect.

The cap detection sensor 136 may detect installation and/or removal of a cap. When the cap is separated from the body 10 (see FIGS. 1 to 3), portions of the cartridge and body 10, which were covered by the cap, may be externally exposed. The cap detection sensor 136 may be implemented as a contact sensor, a hall sensor (hall IC), or an optical sensor.

The motion detection sensor 137 may detect movement of the aerosol generating device 1. The motion detection sensor 137 may be implemented as at least one of an acceleration sensor and a gyro sensor.

The sensor 13 may further include, in addition to the above-described sensors, at least one of a humidity sensor, an atmospheric pressure sensor, a magnetic sensor, a position sensor (global positioning system (GPS)), and a proximity sensor. Functions of each sensor may be intuitively deduced by one of ordinary skill in the art from its name, and thus, detailed description thereof may be omitted.

The output unit 14 may output information on a state of the aerosol generating device 1 and provide the information to a user. The output unit 14 may include at least one of a display 141, a haptic unit 142, and a sound output unit 143, but is not limited thereto. When the display 141 and a touch pad form a layered structure to form a touch screen, the display 141 may also be used as an input device in addition to an output device.

The display 141 may visually provide information about the aerosol generating device 1 to the user. For example, information about the aerosol generating device 1 may mean various pieces of information, such as a charging/discharging state of the power supply 11 of the aerosol generating device 1, a preheating state of the heater 18, an insertion/removal state of an aerosol generating article S, or a state in which the use of the aerosol generating device 1 is restricted (e.g., sensing of an abnormal object), or the like, and the display 141 may output the information to the outside. The display 141 may be in the form of a light-emitting diode (LED) device. For example, the display 141 may be a liquid crystal display (LCD) or an organic light-emitting display panel (OLED).

The haptic unit 142 may tactilely provide information about the aerosol generating device 1 to the user by converting an electrical signal into a mechanical stimulus or an electrical stimulus. For example, when initial power is supplied to the cartridge heater 24 and/or the heater 18 for a set period of time, the haptic unit 142 may generate vibration corresponding to completion of initial preheating. The haptic unit 142 may include a vibration motor, a piezoelectric device, or an electric stimulation device.

The sound output unit 143 may audibly provide information about the aerosol generating device 1 to the user. For example, the sound output unit 143 may convert an electrical signal into a sound signal and output the same to the outside.

The power supply 11 may supply power used to operate the aerosol generating device 1. The power supply 11 may supply power such that the cartridge heater 24 and/or the heater 18 may be heated. In addition, the power supply 11 may supply power required to operate the sensor 13, the output unit 14, the input unit 15, the communication unit 16, and the memory 17, which are other components included in the aerosol generating device 1. The power supply 11 may be a chargeable battery or a disposable battery. For example, the power supply 11 may be a lithium polymer (LiPoly) battery, but is not limited thereto.

Although not illustrated in FIG. 15, the aerosol generating device 1 may further include a power supply protecting circuit. The power supply protecting circuit may be electrically connected to the power supply 11 and include a switching device.

The power supply protecting circuit may block an electric path to the power supply 11 according to a predetermined condition. For example, the power supply protecting circuit may block the electric path to the power supply 11 when a voltage level of the power supply 11 is a first voltage or greater, the first voltage corresponding to overcharging. For example, the power supply protecting circuit may block the electric path to the power supply 11 when the voltage level of the power supply 11 is less than a second voltage corresponding to overdischarging.

The heater 18 may receive power from the power supply 11 to heat a medium or the aerosol generating material in the aerosol generating article S. Although not illustrated in FIG. 15, the aerosol generating device 1 may further include a power conversion circuit (e.g., a direct current (DC)/DC converter) that converts power of the power supply 11 and supplies the same to the heater 18. In addition, when aerosol generating device 1 generates aerosols in an induction heating method, the aerosol generating device 1 may further include a DC/alternating current (AC) converter that converts DC power of the power supply 11 into AC power.

The controller 12, the sensor 13, the output unit 14, the input unit 15, the communication unit 16, and the memory 17 may perform functions by receiving power from the power supply 11. Although not illustrated in FIG. 15, the aerosol generating device 1 may further include a power conversion circuit that converts the power of the power supply 11 and supplies the converted power to respective components, for example, a low dropout (LDO) circuit or a voltage regulator circuit. Also, although not illustrated in FIG. 15, a noise filter may be provided between the power supply 11 and the heater 18. The noise filter may be a low pass filter. The low pass filter may include at least one inductor and a capacitor. A cutoff frequency of the low pass filter may correspond to a frequency of a high-frequency switching current applied from the power supply 11 to the heater 18. The low pass filter may prevent a high-frequency noise component from being applied to the sensor 13, such as the insertion detection sensor 133.

According to an embodiment, the cartridge heater 24 and/or the heater 18 may be formed of any suitable electric resistance material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 18 may be implemented by a metal wire, a metal plate on which an electrically conductive track 242(see FIG. 7 to 10) is arranged, or a ceramic susceptor, but is not limited thereto.

The input unit 15 may receive information input from the user or output information to the user. For example, the input unit 15 may be a touch panel. The touch panel may include at least one touch sensor configured to detect a touch. For example, the touch panel may include a capacitive touch sensor, a resistive touch sensor, a surface acoustic wave touch sensor, or an infrared touch sensor, but is not limited thereto.

The display 141 and the touch panel may be embodied as one panel. For example, the touch panel may be inserted (on-cell type or in-cell type) into the display 141. For example, the touch panel may be added on (add-on type) on a panel of the display 141.

Meanwhile, the input unit 15 may include a button, a keypad, a dome switch, a jog wheel, or a jog switch, but is not limited thereto.

The memory 17 is a hardware component that stores various types of data processed in the aerosol generating device 1, and may store data processed and data to be processed by the controller 30. The memory 17 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 17 may store an operation time of the aerosol generating device 1, the maximum number of puffs, the current number of puffs, at least one temperature profile, data on a user's smoking pattern, etc.

The communication unit 16 may include at least one component for communication with another electronic device. For example, the communication unit 16 may include a short-range wireless communication unit and a wireless communication unit.

The short-range wireless communication unit may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra wideband (UWB) communication unit, an Ant+ communication unit, or the like, but is not limited thereto.

The wireless communication unit may include a cellular network communication unit, an Internet communication unit, a computer network (e.g., local area network (LAN) or wide area network (WAN)) communication unit, or the like, but is not limited thereto.

Although not illustrated in FIG. 15, the aerosol generating device 1 may further include a connection interface such as a USB interface and may be connected to another external device through the connection interface such as the USB interface, to transmit and receive information or to charge the power supply 11.

The controller 12 may control the overall operation of the aerosol generating device 1. In an embodiment, the controller 12 may include at least one processor. The processor may be implemented as an array of a plurality of logic gates, or may be implemented as a combination of a general-purpose microprocessor and a memory in which a program executable by the microprocessor is stored. It will be understood by one of ordinary skill in the art that the processor may be implemented in other forms of hardware.

The controller 12 may control a temperature of the heater 18 by controlling supply of power of the power supply 11 to the heater 18. The controller 12 may control the temperature of the cartridge heater 24 and/or the heater 18, based on the temperature of the cartridge heater 24 and/or the heater 18, which is sensed by the temperature sensor 131. The controller 12 may control power supplied to the cartridge heater 24 and/or the heater 18, based on the temperature of the cartridge heater 24 and/or the heater 18. For example, the controller 12 may determine a target temperature of the cartridge heater 24 and/or the heater 18, based on a temperature profile stored in the memory 17.

The aerosol generating device 1 may include a power supply circuit (not shown) electrically connected to the power supply 11 between the cartridge heater 24 and/or the heater 18. The power supply circuit may be electrically connected to the cartridge heater 24 or the heater 18. The power supply circuit may include at least one switching device. The switching device may be implemented as a bipolar junction transistor (BJT) or a field effective transistor (FET). The controller 12 may control the power supply circuit.

The controller 12 may control power supply by controlling switching of the switching device of the power supply circuit. The power supply circuit may be an inverter configured to convert DC power output from the power supply 11 into AC power. For example, the inverter may be configured as a full-bridge circuit including a plurality of switching devices or as a half-bridge circuit.

The controller 12 may turn on the switching device such that power is supplied from the power supply 11 to the cartridge heater 24 and/or the heater 18. The controller 12 may turn off the switching device such that supply of power to the cartridge heater 24 and/or the heater 18 is blocked. The controller 12 may control a current supplied to the power supply 11 by controlling a duty ratio and/or a frequency of a current pulse input to the switching device.

The controller 12 may control a voltage output from the power supply 11 by controlling switching of the switching device of the power supply circuit. The power conversion circuit may convert the voltage output from the power supply 11. For example, the power conversion circuit may include a buck converter that decreases the voltage output from the power supply 11. For example, the power conversion circuit may be implemented as a buck-boost converter or a Zener diode.

The controller 12 may control a level of a voltage output from the power conversion circuit by controlling an on/off operation of a switching device included in the power conversion circuit. When an on state of the switching device is continued, the level of the voltage output from the power conversion circuit may correspond to a level of the voltage output from the power supply 11. A duty ratio of the on/off operation of the switching device may correspond to a ratio of the voltage output from the power supply 11 to the voltage output from the power conversion circuit. When the duty ratio of the on/off operation of the switching device is decreased, the level of the voltage output from the power conversion circuit may be decreased. The heater 18 may be heated based on the voltage output from the power conversion circuit.

The controller 12 may control power to be supplied to the heater 18 by using at least one of a pulse width modulation (PWM) method and a proportional-integral-differential (PID) method.

For example, the controller 12 may control a current pulse having a predetermined frequency and a duty ratio to be supplied to the heater 18 by using the PWM method. The controller 12 may control power supplied to the heater 18 by controlling the frequency and the duty ratio of the current pulse.

For example, the controller 12 may determine a target temperature of control, based on the temperature profile. The controller 12 may control power supplied to the heater 18 by using the PID method that is a feedback control method using a difference value between a temperature and a target temperature, a value obtained by integrating the difference value over time, and a value obtained by differentiating the difference value over time.

The controller 12 may prevent the cartridge heater 24 and/or the heater 18 from being overheated. For example, the controller 12 may control operations of the power conversion circuit such that supply of power to the cartridge heater 24 and/or the heater 18 is stopped, based on the temperature of the cartridge heater 24 and/or the heater 18 exceeding a pre-set limit temperature. For example, the controller 12 may reduce an amount of power supplied to the cartridge heater 24 and/or the heater 18 by a specific percentage, based on the temperature of the cartridge heater 24 and/or the heater 18 exceeding a pre-set limit temperature. For example, the controller 12 may determine that the aerosol generating material accommodated in the cartridge is exhausted, based on the temperature of the cartridge heater 24 exceeding a limit temperature, and block power supply to the cartridge heater 24.

The controller 12 may control charging and discharging of the power supply 11. The controller 12 may identify a temperature of the power supply 11, based on an output signal of the temperature sensor 131.

When a power line is connected to a battery terminal of the aerosol generating device 1, the controller 12 may identify whether the temperature of the power supply 11 is a first limit temperature or greater, the first limit temperature being a criterion for blocking charging of the power supply 11. When the temperature of the power supply 11 is less than the first limit temperature, the controller 12 may control the power supply 11 to be charged, based on a pre-set charging current. When the temperature of the power supply 11 is the first limit temperature or greater, the controller 12 may block the power supply 11 from being charged.

When power of the aerosol generating device 1 is turned on, the controller 12 may identify whether the temperature of the power supply 11 is a second limit temperature or greater, the second limit temperature being a criterion for blocking discharging of the power supply 11. When the temperature of the power supply 11 is less than the second limit temperature or greater, the controller 12 may control power stored in the power supply 11 to be used. When the temperature of the power supply 11 is the second limit temperature or greater, the controller 12 may stop using power stored in the power supply 11.

The controller 12 may calculate remaining capacity of power stored in the power supply 11. For example, the controller 12 may calculate the remaining capacity of the power supply 11, based on a voltage and/or current detected value of the power supply 11.

The controller 12 may determine whether the aerosol generating article S is inserted into the insertion space, by using the insertion detection sensor 133. The controller 12 may determine insertion of the aerosol generating article S, based on an output signal of the insertion detection sensor 133. When it is determined that the aerosol generating article S is inserted into the insertion space, the controller 12 may control power to be supplied to the cartridge heater 24 and/or the heater 18. For example, the controller 12 may supply power to the cartridge heater 24 and/or the heater 18, based on the temperature profile stored in the memory 17.

The controller 12 may determine whether the aerosol generating article S is removed from the insertion space. For example, the controller 12 may determine whether the aerosol generating article S is removed from the insertion space, by using the insertion detection sensor 133. For example, the controller 12 may determine that the aerosol generating article S is removed from the insertion space when the temperature of the heater 18 is a limit temperature or greater or when a temperature change slope of the heater 18 is a set slope or greater. When it is determined that the aerosol generating article S is removed from the insertion space, the controller 12 may block supply of power to the cartridge heater 24 and/or the heater 18.

The controller 12 may control a power supply time and/or a power supply amount for the heater 18, according to a state of the aerosol generating article S, detected by the sensor 13. The controller 12 may identify a level range including a level of a signal of a capacitance sensor, based on a lookup table. The controller 12 may determine a moisture amount of the aerosol generating article S, according to the identified level range.

When the aerosol generating article S is in an excessive moisture state, the controller 12 may control the power supply time for the heater 18 to increase a preheating time of the aerosol generating article S compared to a normal case.

The controller 12 may determine whether the aerosol generating article S inserted into the insertion space is reused, by using the reuse detection sensor 134. For example, the controller 12 may compare a detected value of a signal of the reuse detection sensor 134 with a first reference range including a first color and when the detected value is within the first reference range, determine that the aerosol generating article S has not been used. For example, the controller 12 may compare the detected value of the signal of the reuse detection sensor 134 with a second reference range including a second color and when the detected value is within the second reference range, determine that the aerosol generating article S has been used. When it is determined that the aerosol generating article S has been used, the controller 12 may block supply of power to the cartridge heater 24 and/or the heater 18.

The controller 12 may determine combination and/or removal of the cartridge by using the cartridge detection sensor 135. For example, the controller 12 may determine whether the cartridge is combined or removed, based on a detected value of a signal of the cartridge detection sensor 135.

The controller 12 may determine whether the aerosol generating material of the cartridge is exhausted. For example, the controller 12 may apply power to pre-heat the cartridge heater 24 and/or the heater 18, determine whether the temperature of the cartridge heater 24 exceeds a limit temperature in a preheating section, and when the temperature of the cartridge heater 24 exceeds the limit temperature, determine that the aerosol generating material of the cartridge is exhausted. When it is determined that the aerosol generating material of the cartridge is exhausted, the controller 12 may block supply of power to the cartridge heater 24 and/or the heater 18.

The controller 12 may determine whether the cartridge is usable. For example, the controller 12 may determine that the cartridge is not usable when the present number of puffs is equal to or greater than a maximum number of puffs set in the cartridge, based on data stored in the memory 17. For example, the controller 12 may determine that the cartridge is not usable when a total time the cartridge heater 24 is heated is equal to or greater than a pre-set maximum time or a total power amount supplied to the cartridge heater 24 is equal to or greater than a pre-set maximum power amount.

The controller 12 may determine inhalation of the user by using the puff sensor 132. For example, the controller 12 may determine whether a puff has occurred, based on a detected value of a signal of the puff sensor 132. For example, the controller 12 may determine strength of a puff, based on the detected value of the signal of the puff sensor 132. The controller 12 may block supply of power to the cartridge heater 24 and/or the heater 18 when the number of puffs reaches a pre-set maximum number of puffs or when a puff is not detected for a pre-set time or greater.

The controller 12 may determine combination and/or removal of a cap by using the cap detection sensor 136. For example, the controller 12 may determine whether the cap is combined or removed, based on a detected value of a signal of the cap detection sensor 136.

The controller 12 may control the output unit 14, based on a result detected by the sensor 13. For example, when the number of puffs counted through the puff sensor 132 reaches a pre-set number, the controller 12 may notify the user that the aerosol generating device 1 will end soon through at least one of the display 141, the haptic unit 142, and the sound output unit 143. For example, the controller 12 may determine that there is no aerosol generating article S in the insertion space and notify same to the user through the output unit 14. For example, the controller 12 may determine that the cartridge and/or the cap is not mounted and notify same to the user through the output unit 14. For example, the controller 12 may transmit, to the user through the output unit 14, information about the temperature of the cartridge heater 24 and/or the heater 18.

The controller 12 may store and update, in the memory 17, a history about an occurred event, based on occurrence of a predetermined event. Examples of the event may include detecting of insertion of aerosol generating article S, starting of heating of the aerosol generating article S, detecting of a puff, ending of a puff, detecting of overheating of the cartridge heater 24 and/or the heater 18, detecting of application of overvoltage to the cartridge heater 24 and/or the heater 18, ending of heating of the aerosol generating article S, turning on/off of the aerosol generating device 1, starting of charging of the power supply 11, detecting of overcharging of the power supply 11, and ending of charging of the power supply 11, which are performed by the aerosol generating device 1. The history about the event may include a time and date when the event has occurred, log data corresponding to the event, and the like. For example, when an event is detecting of insertion of the aerosol generating article S, log data corresponding to the event may include data about a detected value of the insertion detection sensor 133. For example, when an event is detecting of overheating of the cartridge heater 24 and/or the heater 18, log data corresponding to the event may include data about the temperature of the cartridge heater 24 and/or the heater 18, a voltage applied to the cartridge heater 24 and/or the heater 18, and a current flowing through the cartridge heater 24 and/or the heater 18.

The controller 12 may control a communication link to an external device, such as a mobile terminal of the user, to be formed. When data about authentication is received from the external device through the communication link, the controller 12 may release restriction on using at least one function of the aerosol generating device 1. Here, the data about the authentication may include data indicating completion of user authentication of the user corresponding to the external device. The user may perform the user authentication through the external device. The external device may determine whether user data is valid, based on the user's birthday, a unique number indicating the user, or the like, and receive, from an external server, data about use authority of the aerosol generating device 1. The external device may transmit, to the aerosol generating device 1, the data indicating the completion of the user authentication, based on the data about the use authority. When the user authentication is completed, the controller 12 may release the restriction on using at least one function of the aerosol generating device 1. For example, when the user authentication is completed, the controller 12 may release restriction on using a heating function of supplying power to the heater 18.

The controller 12 may transmit data about a state of the aerosol generating device 1 to the external device through the communication link formed with the external device. The external device may output, based on the received data about the state, an operating mode, remaining capacity, or the like of the power supply 11 of the aerosol generating device 1 through a display of the external device.

The external device may transmit, to the aerosol generating device 1, a location search request, based on an input of starting a location search of the aerosol generating device 1. When the location search request is received from the external device, the controller 12 may control, based on the received location search request, at least one of output devices to perform an operation corresponding to the location search. For example, the haptic unit 142 may generate vibration, based on the location search request. For example, the display 141 may output an object corresponding to the location search and a search end, based on the location search request.

Upon receiving firmware data from the external device, the controller 12 may control firmware update to be performed. The external device may identify a current version of firmware of the aerosol generating device 1 and determine whether there is a new version of firmware. When an input requesting to download firmware is received, the external device may receive a new version of firmware data and transmit the new version of firmware data to the aerosol generating device 1. Upon receiving the new version of firmware data, the controller 12 may control the firmware update of the aerosol generating device 1 to be performed.

The controller 12 may transmit data on a detected value of at least one sensor 13 to an external server (not shown) through the communication unit 16 and receive a learning model generated by learning the detected value through machine learning, such as deep learning, from the server and store the learning model. The controller 12 may perform an operation of determining an inhalation pattern of the user, an operation of generating a temperature profile, and the like, by using the learning model received from the external server. The controller 12 may store, in the memory 17, detected value data of the at least one sensor 13, data for training an artificial neural network (ANN), and the like. For example, the memory 17 may store database about each configuration included in the aerosol generating device 1, a weight configuring a structure of the ANN, a bias, and the like, for training the ANN. The controller 12 may generate at least one learning model used to determine the inhalation pattern of the user, generate the temperature profile, and the like, by learning a temperature profile, an inhalation pattern of a user, data about a detected value of the at least one sensor 13, which are stored in the memory 17.

Any or other embodiments described above may not be exclusive or distinguished from each other. Any or other embodiments described above may have configurations or functions combined or associated with each other.

For example, a component A described in a specific embodiment and/or drawing may be combined with a component B described in another embodiment and/or drawing. In other words, even when a combination between components is not directly described, a combination may be possible, except in cases where it is described that a combination is impossible.

The above detailed description should not be construed as restrictive in any respect and should be considered illustrative. The scope of the disclosure should be determined by reasonable interpretation of the appended claims, and all changes within the equivalent scope of the disclosure are included in the scope of the disclosure.

An aerosol generating device, an aerosol generating system, and an aerosol generating method, according to various embodiments, may increase power efficiency by supplying power independently to a plurality of electrically conductive tracks.

An aerosol generating device, an aerosol generating system, and an aerosol generating method, according to various embodiments, may prevent overheating by sequentially heating a plurality of electrically conductive tracks.

An aerosol generating device, an aerosol generating system, and an aerosol generating method, according to various embodiments, may increase durability and life through a plurality of electrically conductive tracks.

An aerosol generating device, an aerosol generating system, and an aerosol generating method, according to embodiments, may determine a temperature of a heater by using some of a plurality of electrically conductive tracks, without having to use a separate temperature sensor.

The effects of the embodiments are not limited to the above-described effects, and effects not mentioned will be clearly understood by one of ordinary skill in the art to which the embodiments belong from the present specification and the accompanying drawings.

What is claimed is:

1. An aerosol generating device comprising:
a heater configured to generate aerosols by heating an aerosol generating material;
a power supply configured to supply power to the heater; and
a controller configured to control operations of the power supply and the heater,
wherein the heater comprises:
a sheet including a first heating region and a second heating region;
a first track that is heated by receiving power and arranged in the first heating region; and
a second track that is heated by receiving power and arranged in the second heating region, and
the controller is further configured to control the power supply to supply power to the second track when a predetermined time has elapsed after starting to supply power to the first track.

2. The aerosol generating device of claim 1, wherein the first track and the second track independently receive power from the power supply.

3. The aerosol generating device of claim 1, wherein the first heating region and the second heating region at least overlap each other.

4. The aerosol generating device of claim 1, wherein at least a portion of the first track includes a first pattern region in which an extending direction is regularly changed, and
at least a portion of the second track includes a second pattern region in which an extending direction is regularly changed.

5. The aerosol generating device of claim 1, wherein the controller is further configured to calculate information about a temperature, based on an amount of current flowing through the first track or the second track.

6. The aerosol generating device of claim 1, wherein the sheet comprises an electric conductive material, and
the controller is further configured to calculate information about a temperature, based on an amount of current flowing through the sheet.

7. An aerosol generating system comprising:
the aerosol generating device of claim 1; and
an aerosol generating article including a generating portion that includes the aerosol generating material and configured to generate aerosols by being heated by the aerosol generating device.

8. The aerosol generating system of claim 7, wherein, when the generating portion is heated, an aerosol stream including the aerosols flows from one end portion to another end portion of the generating portion, and
an end portion of at least one of the first track and the second track is arranged at a location corresponding to the other end portion of the generating portion.

9. The aerosol generating system of claim 7, wherein, when the generating portion is heated, an aerosol stream including the aerosols flows from one end portion to another end portion of the generating portion, and
an end portion of at least one of the first track and the second track is arranged apart from the other end portion of the generating portion by a predetermined distance in a direction the aerosol stream flows.

10. An aerosol generating method for an aerosol generating device that is heated by receiving power and includes a first track and a second track, which generate aerosols by heating an aerosol generating material, the aerosol generating method comprising:
supplying power to the first track; and
supplying power to the second track when a first time has elapsed after the supplying of the power to the first track.

11. The aerosol generating method of claim 10, further comprising calculating information about a temperature, based on an amount of current flowing through the second track before the first time has elapsed after the supplying of the power to the first track.

12. The aerosol generating method of claim 10, further comprising:
stopping the supplying of the power to the second track when a second time has elapsed after the supplying of the power to the second track; and
stopping the supplying of the power to the first track when a third time has elapsed after the stopping of the supplying of the power to the second track.

13. The aerosol generating method of claim 12, further comprising calculating information about a temperature, based on an amount of current flowing through the second track before the third time has elapsed after the stopping of the supplying of the power to the second track.

14. The aerosol generating method of claim 10, further comprising:
reaching a maximum value of the power supplied to the first track after the supplying of the power to the first track; and
reaching a maximum value of the power supplied to the second track after the reaching of the maximum value of the power supplied to the first track.

15. The aerosol generating method of claim 10, wherein a size of the power supplied to the second track follows a size of the power supplied to the first track before a fourth time has elapsed after the supplying of the power to the second track; and
the size of the power supplied to the first track follows the size of the power supplied to the second track when the fourth time has elapsed after the supplying of the power to the second track.
